(19) United States
(12) Patent Application Publication
(10) Pub. No.: US 2024/0327118 A1
(43) Pub. Date: Oct. 3, 2024

(54) Mechanical levers for extendable arms of an automated storage system shuttle

(71) Applicant: Cleveron AS, Viljandi (EE)

(72) Inventor: Mart Leib, Viljandi (EE)

(21) Appl. No.: 18/347,258

(22) Filed: Jul. 5, 2023

Related U.S. Application Data
(60) Provisional application No. 63/493,151, filed on Mar. 30, 2023.

(51) Int. Cl. B65G 1/04; B65G 1/06

(52) U.S. Cl. CPC B65G 1/0492; B65G 1/065; B65G 2203/0283; B65G 2203/042

(57) ABSTRACT

A loader of a warehouse shuttle is disclosed where extendable arms reaching to warehouse shelves comprise mechanical levers at distal ends of the extendable arms to hold a crate between the extendable arms. The mechanical levers are configured to rotate between a horizontal bottom position and a vertical upward position through operation of a crankshaft mechanism located in the extendable portions of the arms.

### PRIORITY

This application claims priority of U.S. provisional application No. 63/493,151 filed on Mar. 30, 2023.

### FIELD OF THE INVENTION

This invention relates to load handling systems, especially in a warehouse setting, even more specifically to unmanned warehouse shuttle with telescopic arms and to a dynamic system capable of securely retrieving and disposing items of different sizes from and to the warehouse shelves.

### BACKGROUND OF THE INVENTION

There are numerous disclosures for various kinds of load handling systems in a warehouse setting. A general feature of the systems includes a shuttle device moving between the warehouse shelves and reaching to retrieve packages, or items from the shelf to transport the package or items to a destination. A problem that many of the disclosures address is either how to load more than one package onto the shuttle at the very same time to optimize the ‘shuttle traffic’, or how to enable picking packages of different sizes onto the shuttle.

U.S. Pat. No. 10,865,042 as well as U.S. Pat. No. 9,552,781 disclose a device for gripping a load, wherein the system has chassis elements that are moving in relation to each other to change the width between gripping arms that are attached to the chassis portions and that way adopt to loading items of different widths. The system includes locking mechanisms to lock the chassis elements to preferred distance from each other. Drive assemblies including a rotatable drum and a cable extends and retracts the telescopic arms.

U.S. Pat. No. 8,790,061 discloses a transferring shuttle for use in an automated warehouse. The shuttle has extendable units in both sides of a carrying area and at the distal ends as well as in the inner surfaces of the extendable units there are motorized fingers that may be in contracted position or in an extended position so that in extended position the terminal fingers are located behind the package and the fingers inside the units are located in front of the package to facilitate pushing the package in or pulling it out from the warehouse shelf.

U.S. Pat. No. 10,894,663 discloses an autonomous transport vehicle having a payload area and telescoping arms mounted thereto. The telescoping arms may have motorized finger members to be positioned behind the pick face to pull the pick face off the shelf.

U.S. Pat. No. 6,923,612 discloses a telescopic arm of a load-handling system for transferring storage units in and out of a rack stage. The distal ends and middle section of the arms comprise motor operated pivotable drivers that in their operating positions will hold a storage unit in between of the drivers.

Thus, even if there are solutions that provide reaching deep into the storage shelves to retrieve one or more packages at same time, and suggesting as how to modify the width of the loading space of the shuttle, a simple and secure solution is still needed to keep the retrieved package tightly in a steady position while pulling it out from the shelf or when pushing it off from the loading space of the shuttle. This disclosure provides a mechanical solution to hold a crate or package steady on the shuttle, and to retrieve or deliver a crate or package from or to a warehouse shelf. A mechanical solution requires less service and is more reliable than any motorized solutions.

### SUMMARY OF THE INVENTION

An automated storage system includes a rack with multiple levels of shelves defining item storage positions, an aisle at each level, and shuttles to operate in the aisles for storing items and retrieving items from the storage positions on each level. Loading and/or unloading items from the storage positions employ multiple axes (pincher, arms, and levers) of movement. Mechanical lever shaft drive uses the force generated by the pincher axis to lower or rise the levers when the pusher makes contact with the item or crate to be moved. The levers are used as collectors (or rakes) to hook behind the items or crates in the loading and/or unloading procedure.

It is an object of this invention to provide:

A loader of a warehouse shuttle comprising two extendable arms and an open-ended loading space in between the arms;
the extendable arms are configured to extend through the open ends of the loading space into two opposite directions and each extendable arm comprises a non-extendable pincher portion and an extendable portion located on an inner side of the pincher portion; the non-extendable pincher portions of the arms are adjustably connected to each other to allow horizontal movement of the pincher portions toward and away from each other to adjust the distance between the arms;
distal ends of the extendable portions comprise mechanical levers configured to rotate between a horizontal bottom position and a vertical upward position through operation of a crankshaft mechanism located in the extendable portions; wherein the crank shaft mechanism comprises a crankshaft rotatably mounted on the extendable arm via a carrier shaft and attached from each of its ends via a shaft bearing to a mechanical lever, wherein the crankshaft comprises a rod journal having a central axis offset from a central axis of the shaft, and a horizontal movement of the pincher portion is converted to rotational movement of the shaft via a pusher fixedly connected to the rod journal and rotatably via the carrier shaft to the extendable portion;
and wherein the rotational movement of the crankshaft is configured to move the mechanical levers between the upward and bottom positions.

In certain embodiments the crank shaft mechanism comprises multiple rod journals and multiple pushers.

In certain embodiments the loader arm has at least two sensors, one in each end of the crankshaft, and at least one sensor at each end is configured to become blocked when the mechanical lever adjacent to the sensor is in upward position and at least one sensor is configured to become blocked when the adjacent mechanical lever is in bottom position, and wherein each sensor is configured to send a signal while blocked to a computerized system of the warehouse shuttle, and the computerized system is configured to read the signals indicating all levers to be in bottom position meaning that a crate is safely held in between the loader arms.

In certain aspects the crankshaft comprises more than one rod journal each of which has a pusher rotatably connected to thereto.

It is an object of this invention to provide a crankshaft arrangement to control mechanical levers configured to keep a crate in between extendable arms of a warehouse shuttle, wherein the arrangement comprises:
a crankshaft comprising at least one rod journal having a central axis offset from a central axis of the shaft;
at least one carriage connected to the crankshaft and to the extendable arm;
at least one pusher rotatably connected to a carrier shaft of the at least one carriage and fixedly connected to at least one rod journal; in which arrangement:
a horizontal movement of the extendable arms toward each other and against a crate is configured to cause a horizontal force against the at least one pusher causing rotational movement of the at least one pusher around the axis of the carriage, the rotational movement further causing a movement of the at least one rod journal which transfers the rotational movement into a rotational movement of the crankshaft and thereby rotating mechanical levers attached to each end of the shaft from a vertical upward positions to a horizontal bottom position where the levers keep the crate loaded in between the extendable arms.

In certain aspects, the crank shaft arrangement has one rod journal, one carriage and one pusher.

In certain embodiments the crankshaft arrangement comprises at least two sensors at each end of the shaft, such that at least one sensor at each end of the crankshaft becomes blocked when the mechanical lever adjacent to the sensor is in upward position and at least one sensor is blocked when the adjacent mechanical lever is in bottom position, and wherein the sensors are configured to communicate their status of being blocked to a computerized system of the warehouse shuttle.

### BRIEF DESCRIPTION OF THE DRAWINGS

FIG. 1 shows an overview of an empty shuttle (1). The figure shows the extendable arms (6) in retracted position, the loading space (7), the pinchers (8) and the levers (15) in upright position (17). A pusher (9) is shown in an outward position.

FIG. 2 shows a side view of the shuttle (1) when a crate (10) is on the loading space (7), before the pinchers (8) have moved the extendable arms (6) against the crate. Pushers (9) are in the outward position (25).

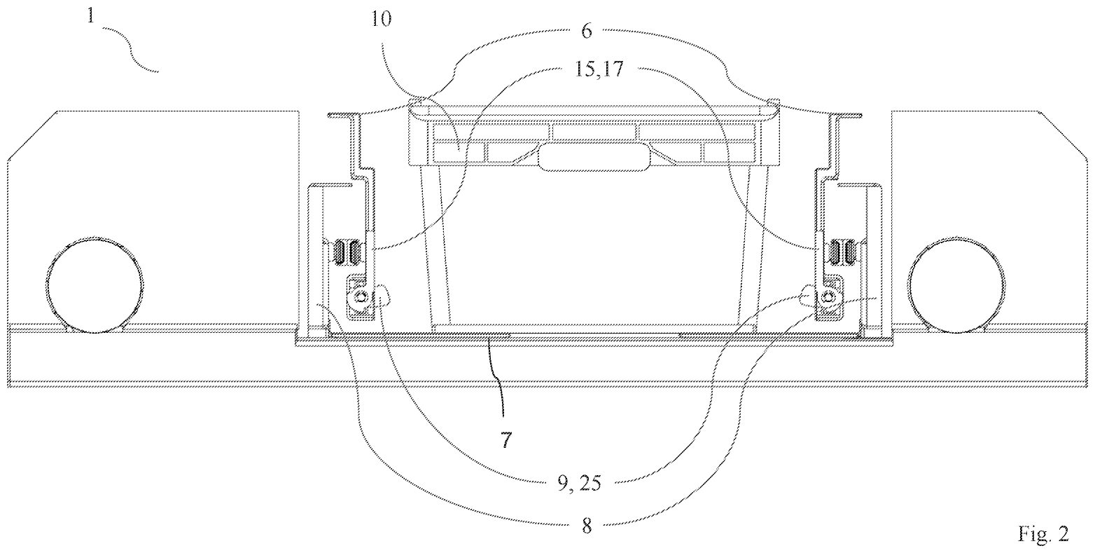

FIG. 3 shows an overview of the shuttle (1) when a crate (10) is on the loading space (7). The pinchers (8) have moved the extendable arms (6) that are still in retracted position against the crate and the levers (15) are in horizontal bottom position (18).

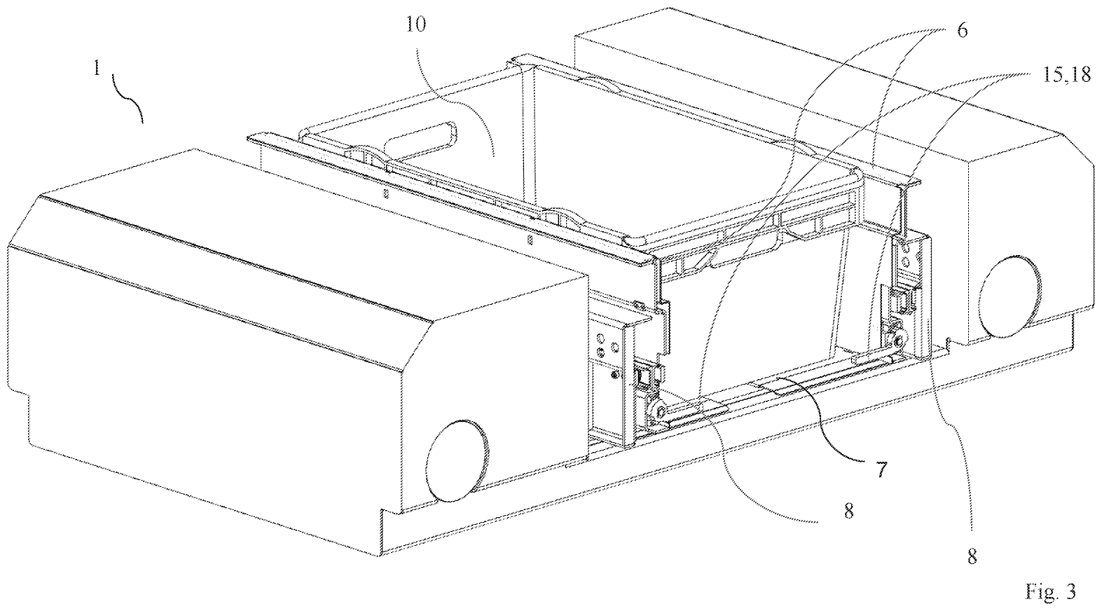

FIG. 4 shows a side view of the shuttle (1) when the crate (10) is in the loading space, the pinchers (8) have moved the extendable arms (6) against the crate (10). In this Figure it can be seen that when the pinchers have moved the extendable arms against the crate, the horizontal force caused by interaction between the crate and pushers moves the pushers (9) into inwards position (24) which again causes the levers (15) to move to the horizontal bottom position (18) which can be understood from FIG. 5. Similarly, when the connection between the crate and the extendable arms is lost when the pinchers move the arms further apart, the pusher is released to outward position due to lack of horizontal force and with the help of springs the crankshaft turns to move the levers to vertical upright position.

FIG. 5 is a cut off figure of the shuttle; only half of the shuttle is shown to illustrate the mechanism of moving the levers (15). The opposite side of the shuttle would be identical. Shaft drive (2) is shown in a dotted rectangle, and it is shown to comprise a crankshaft (11), a pusher (9) shown here in outward position (25), pillow blocks (23) and rigid couplers (4). At both ends of the shaft drive (2) are shaft ends (3) both of which are also shown here in dotted rectangles and comprise bearing housing (12) and the levers (15). The figure reveals how the pusher (9) can move to an inward position by rotation when a crate is pushed against the pusher. When the pusher rotates the crankshaft (11) rotates and that rotates the levers (15).

FIG. 6 is a detailed view of the shaft end (3). The rigid coupler (4), bearings (13) and bearing house (12), the lever (15) and sensors (16a and 16b) of the shaft end (3) are visible. The crankshaft (11) is connected to the rigid coupler (4) and the rigid coupler to the lever shaft (14) which is partially visible here. The lever (15) is in vertical upright position here.

FIG. 7 is another illustration of the shaft end (3). The bearing house (12) shown in FIG. 6 is removed here to show the inner parts. The lever shaft (14) can be seen here. Also, the bearings (13) are well visible here. The crankshaft (11) is connected to the rigid coupler (4) and the rigid coupler to the lever shaft (4).

FIG. 8 shows the shaft drive (2) in an isolated side view. The figure shows the crankshaft (11) and the connecting rod journal (19) where the pusher (9) is attached. The figure illustrates by dotted lines a position of the center line of the connecting rod journal (9) in its downward and upward positions 20, and 21 respectively. Element (22) illustrates a carrier, the purpose of which is to provide a rotational axis for the pusher (9).

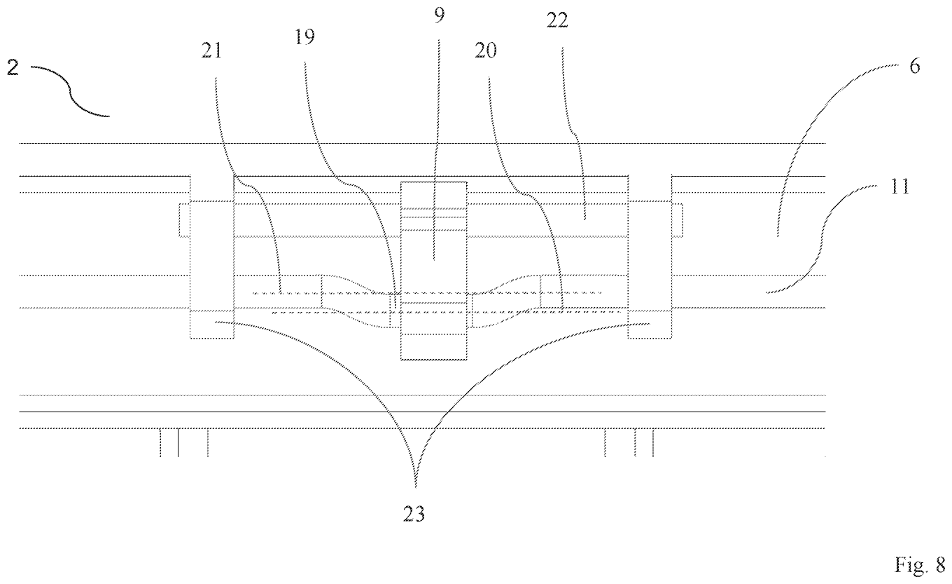

FIG. 9 shows the shaft end (3) in an isolated view of an alternative embodiment to the embodiment shown in FIG. 6. Here the coupler is a flexible coupler (5).

FIG. 10 shows loading of the crate (10) onto the shuttle (1) loading space (7) from the self (26) while the arms (6) are partially extended and levers (15) are in the horizontal bottom position (18).

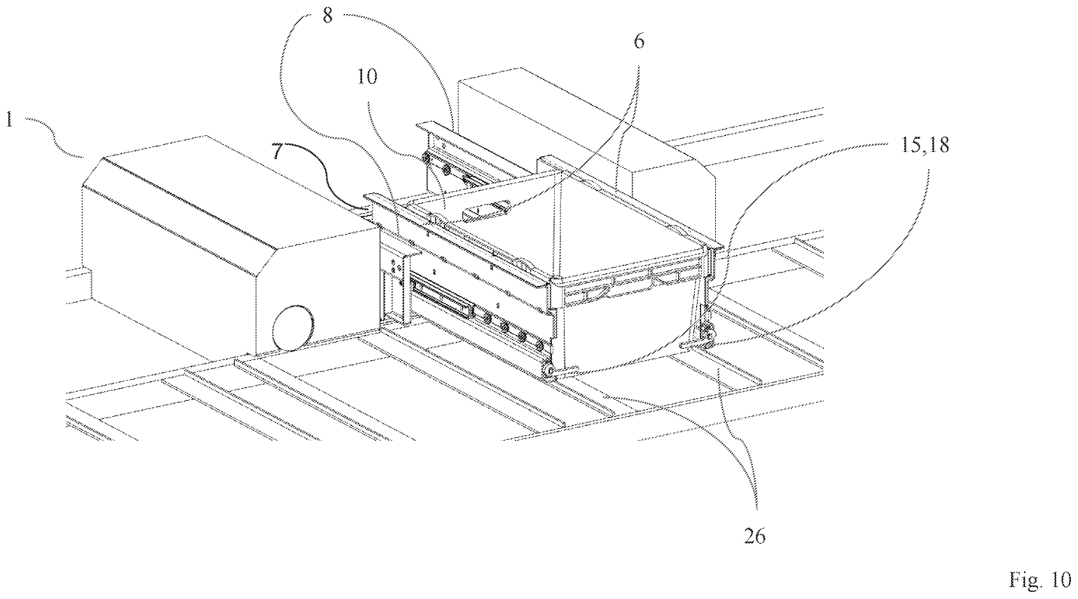

FIG. 11 shows the unloading of the crate (10) from the shuttle (1) loading space to the shelf while the arms (6) are partially extended, and levers (15) are in the horizontal bottom position (18).

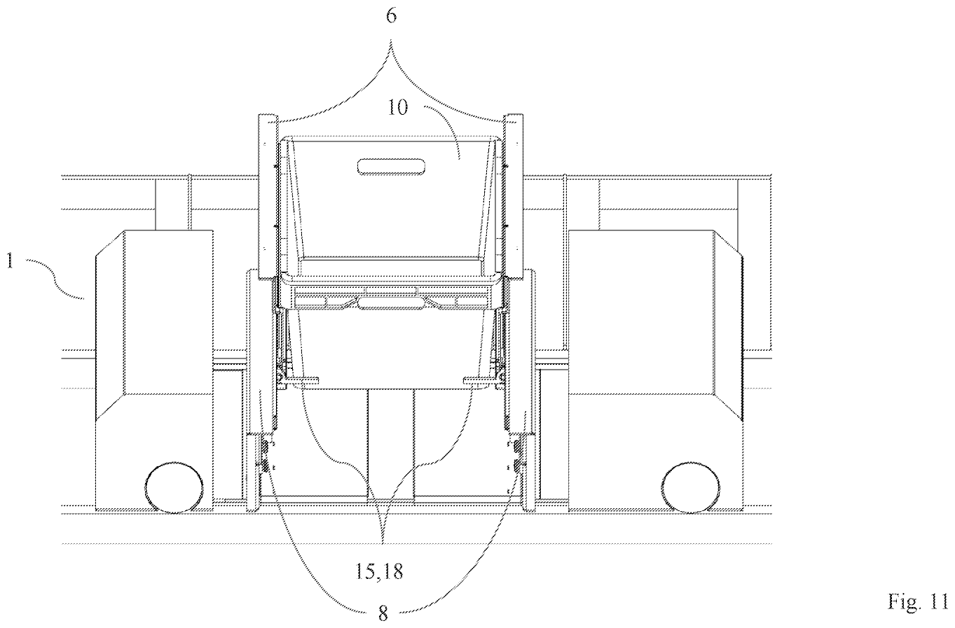

### DETAILED DESCRIPTION OF THE INVENTION

The invention is now described with reference to the figures.

The mechanical levers and their working mechanism described and disclosed here are suitable for use in a warehouse shuttle having extendable arms and a loading space formed in between the arms. A suitable warehouse shuttle is disclosed in U.S. patent application No. 63/358,971 to Cleveron AS.

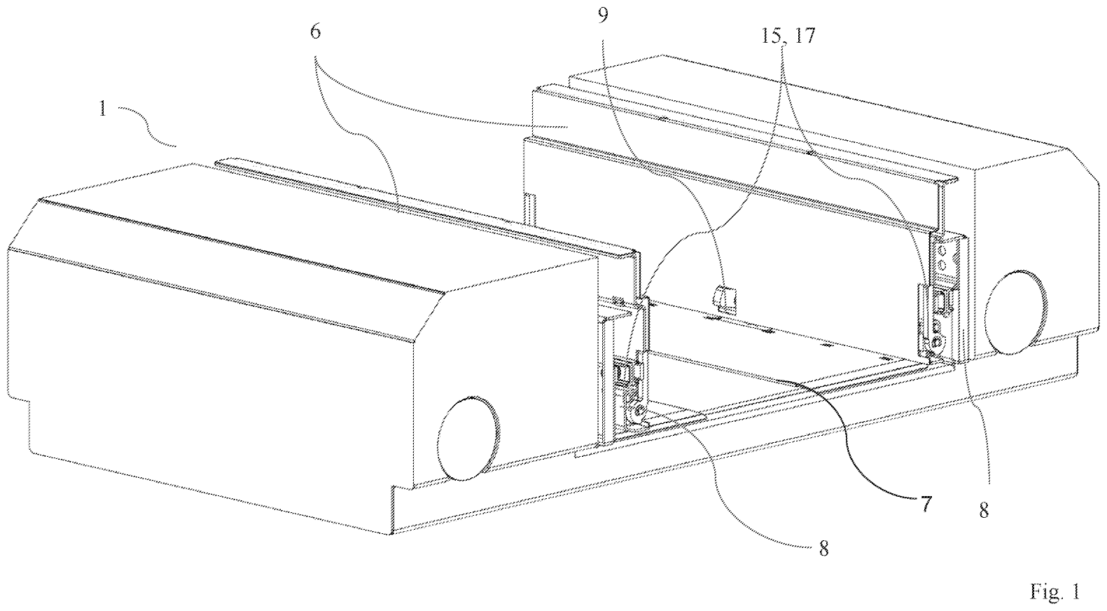

The mechanical levers are part of the warehouse shuttle telescopic arm assembly which comprises two parallel telescopic arms assembled on a platform of the shuttle such that an open ended loading space (7) is formed in between the arms (6) as is shown e.g. in FIG. 1. Each arm comprises one stationary part, and at least one, but preferably two extending parts capable to extend over an edge of the platform toward shelves of the warehouse. The arm parts are located such that in each arm the part that extends furthest is located innermost, i.e. closest to center of the loading space. The arms are capable of extending in two directions; i.e., across both open ends of the loading space. Both of the arms of the shuttle have mechanical levers (15) at both distal ends of the extending part that extends furthest, i.e., is capable of reaching deepest into the warehouse shelf.

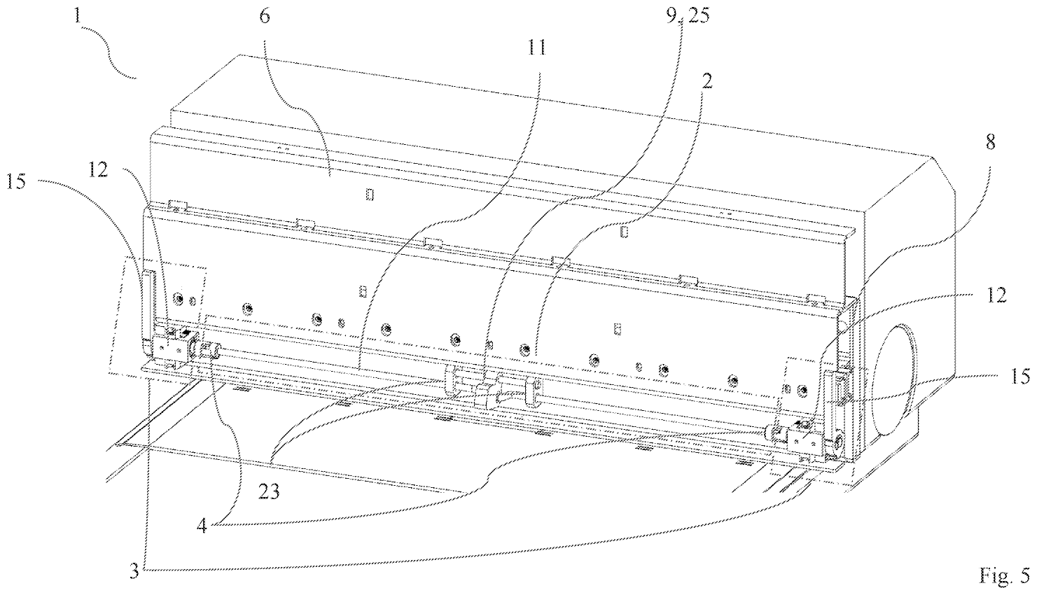

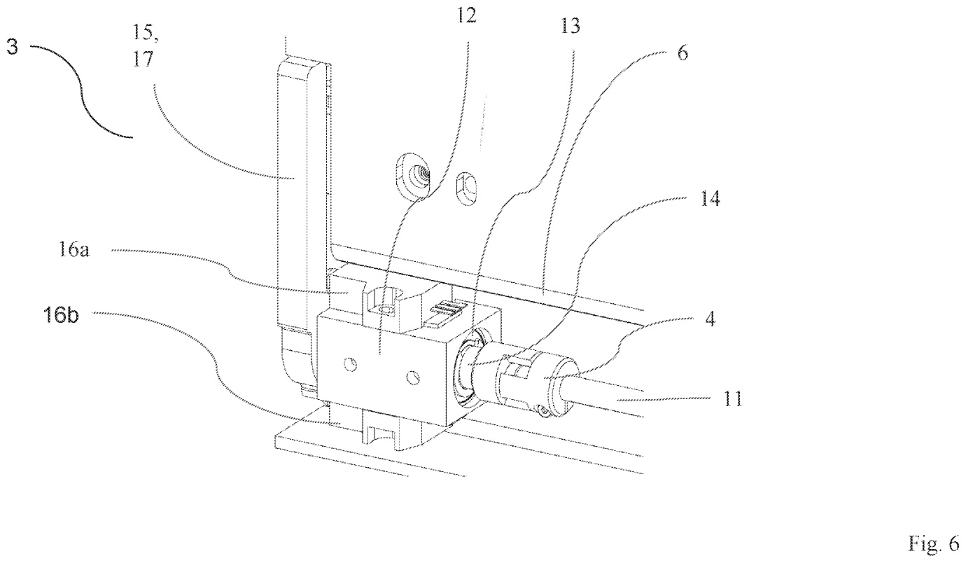

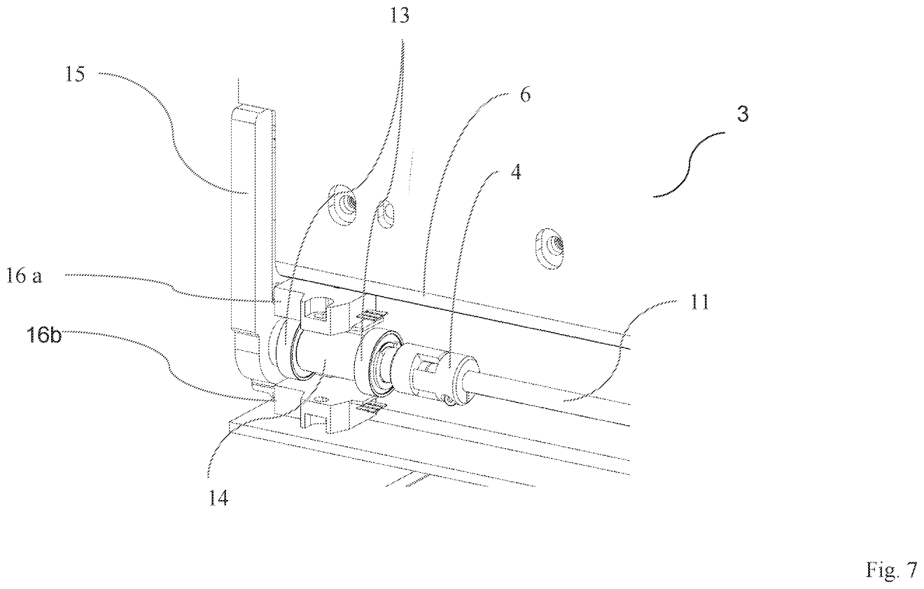

The mechanism to move the mechanical levers (15) comprise two subsystems: the shaft drive (2) and the shaft ends (3); both of these subsystems are shown in dotted rectangles in FIG. 5. Shaft ends (3) are additionally shown in detailed views in FIGS. 6 and 7. The shaft drive (2) is configured to translate (i.e., convert) a horizontal (or reciprocating) movement into a rotational movement based on a crankshaft system. The horizontal movement is created when a crate (10) is inserted into the loading space (7) and pincher (8) moves the arms (6) closer to the crate which causes the crate to become in contact with the outward positioned pushers (9) in both arms. Due to this movement the pushers (9) move horizontally into an inward position. Pusher (9) is mounted on a carrier shaft (22) that is offset from the crankshaft (11) to allow hinged movement off-axis.

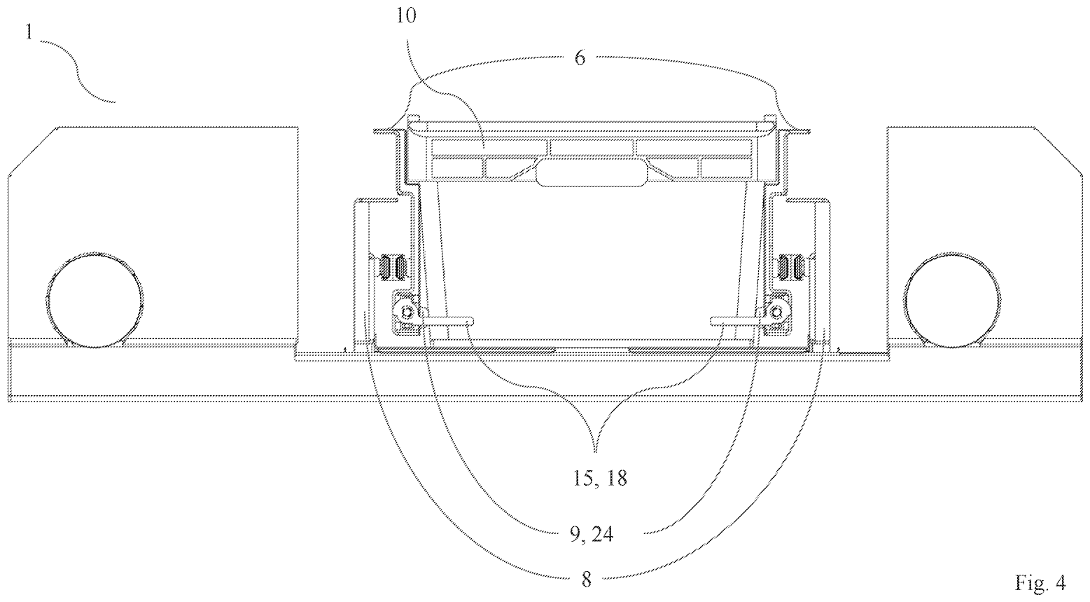

When the crate (10) contacts the pusher (9) it is pushed inwards (24) which results in hinged movement around the carrier shaft (22) axis. Pusher (9) is also connected to the rod journal(s) (19) via a slot that transfers horizontal force from the crate (10) pushing against the pusher (9) to the rod journal(s) (19) resulting in the crankshaft (11) rotating. Shaft ends (3) are configured to use the aforementioned rotational movement of the shaft to raise or lower the levers (15), i.e. rotation of the shaft is used to cause the levers to be either at a vertical upright position (17) or at a horizontal bottom position (18). When a lever (15) is at bottom position (18) it is typically behind the crate (10) which is ready to be pulled out from a shelf or pushed out from the loading space of the shuttle (c.f. FIG. 4). Moreover, all the four mechanical levers of the shuttle (one in each distal end of each arm) are in horizontal bottom positions when a crate is loaded onto the shuttle and the shuttle is moving along the rails in the warehouse. The levers are in this case providing an additional retention to keep the crate in the moving shuttle. When the loading space (7) is empty and the shuttle is moving in the warehouse, all the four mechanical levers (15) are in vertical upright position.

The shaft drive (2) and the shaft ends are located along an inner surface of the arm part that extends furthest. The crankshaft (11) is mounted to the arm (6) preferably by using pillow blocks (23) which also support the pusher (9) carrier shaft (22) (shown in FIG. 5).

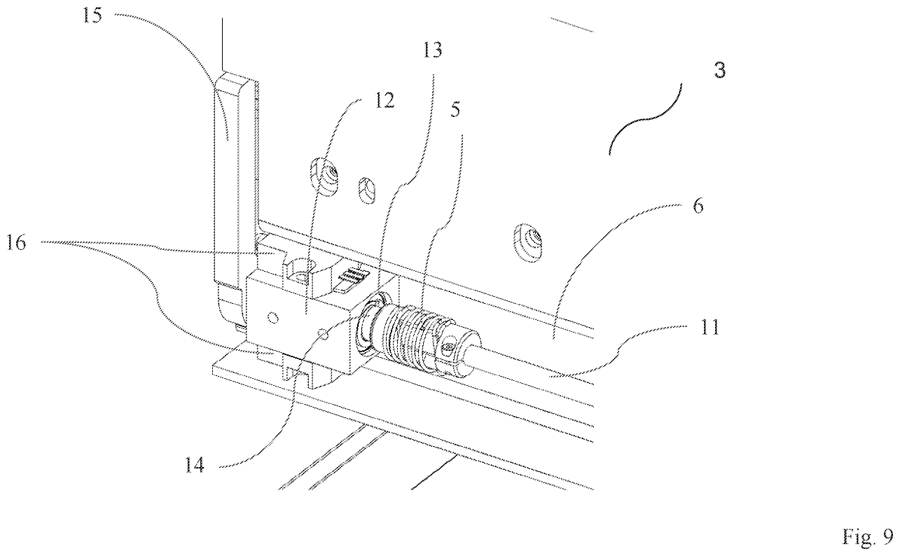

The shaft drive (2) and the shaft ends (3) can be connected using rigid (4) or flexible couplers (5) (FIGS. 7 and 9, respectively). The flexible couplers may also employ springs (illustrated in FIG. 9) to provide a flexible connection.

Shuttle (1) has arms (6) that can extend to the shelves of the warehouse such that the stored crate that is to be retrieved will be in between the extended arms. To achieve the required clearance for the movement of the arms to reach to the shelf, the shuttle (1) also has a pincher (8) axis that can move arms closer or further from each other. The pincher axis is located underneath the loading space, and it connects the arms together. The pincher axis is configured to move the arms closer to each other or further away from each other. When the shuttle (1) has extended the arms (6) to the required extent, the pincher (8) axis moves the arms (6) closer to each other to encapsulate the crate tightly between the loader arms (6). While the pincher (8) moves the arms (6), the pushers (9) make a contact with the crate (10) which translates (or converts) the horizontal (or reciprocating) movement of the pusher (9) into rotational movement of the crankshaft (11).

The rotational movement of the crankshaft (11) is transferred to the shaft ends (3) using the couplers (4) and (5). Shaft end (3) consists of bearings housing (12), bearings (13), lever shaft (14), lever (15), and sensors (16). Bearings (13) are used to reduce the force needed for the rotational movement, and to transfer axial force (or load) from the loading and unloading of the crate (10) to the arm (6) via the bearing housing (12).

Each shaft end comprises an upper and a lower sensor (16a and 16b respectively). The sensors are configured to detect the position of the levers. When a lever (15) is in an upright position (17), the lever reflects the sensor output (16a) (see FIG. 6) causing the upper sensor to detect the lever. When lever (15) is in the bottom position (18), the lower sensor (16b) would detect the lever. Based on the sensors (16) outputs a computerized system of the shuttle (1) determines if it is safe to move the arms (6). For example, when the arms are extended to reach a crate from the warehouse shelf, the system allows the arms to be retracted only when all four mechanical levers of the arms (2 levers in each) are detected by the sensors to be in bottom position. Similarly, when a crate is loaded onto the loader, the system allows the shuttle to start moving only when all four mechanical levers of the art mar detected by the sensors to be in bottom position.

### List of Elements

1 Shuttle
2 Shaft drive
3 Shaft end
4 Rigid coupler
5 Flexible coupler
6 Extendable arms
7 Loading space
8 Pincher
9 Pushers
10 Crate
11 Crankshaft
12 Bearing housing
13 Bearing(s)
14 Lever shaft
15 Lever(s)
16a Upper sensor
16b Lower sensor
17 Upright position
18 Bottom position
19 Rod journal
20 Centerline of the rod journal
21 Centerline of the shaft
22 Carrier shaft
23 Pillow blocks
24 Inwards position
25 Outwards position
26 Shelf

What is claimed is:

1. A loader of a warehouse shuttle comprising two extendable arms and an open-ended loading space in between the extendable arms;
the extendable arms are configured to extend through open ends of the open-ended loading space into two opposite directions and each extendable arm comprises a non-extendable pincher portion and an extendable portion located on an inner side of the non-extendable pincher portion;
the non-extendable pincher portions of the extendable arms are adjustably connected to each other to allow horizontal movement of the non-extendable pincher portions toward and away from each other to adjust a distance between the arms; and
distal ends of the extendable portions comprise mechanical levers configured to rotate between a horizontal bottom position and a vertical upward position through operation of a crankshaft mechanism located in the extendable portions; wherein
the crankshaft mechanism comprises a crankshaft rotatably mounted on the extendable arm via a carrier shaft and attached from each of its ends via a shaft bearing to a mechanical lever, wherein the crankshaft comprises a rod journal having a central axis offset from a central axis of the crankshaft, and a horizontal movement of the non-extendable pincher portion is converted to rotational movement of the crankshaft via a pusher fixedly connected to the rod journal and rotatably via the carrier shaft to the extendable portion; and wherein
the rotational movement of the crankshaft is configured to move the mechanical levers between the vertical upward and horizontal bottom positions.

2. The loader of claim 1, wherein the crankshaft mechanism comprises multiple rod journals and multiple pushers.

3. The loader of claim 1, wherein the loader comprises at least two sensors in each end of the crankshafts, and at least one sensor at each end is configured to become blocked when the mechanical lever adjacent to the sensor is in upward position and at least one sensor is configured to become blocked when the adjacent mechanical lever is in bottom position, and wherein each sensor is configured to send a signal of their status of being blocked to a computerized system of the warehouse shuttle, and the computerized system is configured to read the signals indicating all levers to be in horizontal bottom position to mean that a crate is safely held in between the extendable arms.

4. The loader of claim 1, wherein the crankshaft comprises more than one rod journal each of which has a pusher rotatably connected to thereto.

5. A crankshaft arrangement to control mechanical levers configured to support a crate in between extendable arms of a warehouse shuttle, wherein the crankshaft arrangement comprises:
a crankshaft comprising at least one rod journal having a central line off from a central axis of the crankshaft;
at least one carriage connected to the crankshaft and to the extendable arm;
at least one pusher rotatably connected to a shaft of the at least one carrier sshat and fixedly connected to one of the at least one rod journal;
in which arrangement:
a horizontal movement of the extendable arms toward each other is configured to cause a horizontal force against the at least one pusher causing rotational movement of the at least one pusher around the axis of the carriage, the rotational movement further causing a movement of the at least one rod journal which transfers the rotational movement into a rotational movement of the crankshaft and thereby rotational movement of the mechanical levers attached to each end of the shaft from a vertical upward positions to a horizontal bottom position where the levers support the crate loaded in between the extendable arms.

6. The crankshaft arrangement of claim 5, wherein the crankshaft arrangement has one rod journal, one carriage, and one pusher.

7. The crankshaft arrangement of claim 5, wherein the crankshaft arrangement further comprises at least two sensors at each end of the crankshaft, such that at least one sensor at each end of the crankshaft becomes blocked when the mechanical lever adjacent to the sensor is in vertical upward position and at least one sensor is blocked when the adjacent mechanical lever is in horizontal bottom position, and wherein the sensors are configured to communicate their status of being blocked to a computerized system of the warehouse shuttle.
